(19) United States
(12) Patent Application Publication
(10) Pub. No.: US 2023/0190551 A1
(43) Pub. Date: Jun. 22, 2023

(54) WHEELCHAIR BARRIER ATTACHMENT DEVICE

(71) Applicant: NAJAM AZMAT, DACULA, GA (US)

(72) Inventor: NAJAM AZMAT, DACULA, GA (US)

(21) Appl. No.: 18/072,869

(22) Filed: Dec. 1, 2022

Related U.S. Application Data
(60) Provisional application No. 63/291,390, filed on Dec. 18, 2021.

(51) Int. Cl. A61G 5/10; B62D 25/16

(52) U.S. Cl. CPC A61G 5/10; B62D 25/161; B62D 25/163

(57) ABSTRACT

A wheelchair barrier attachment device prevents contamination of particles picked up from the ground by the wheelchair, by allowing the barrier between the wheel of the wheelchair and the propulsion rim in which the user must touch to operate the wheelchair.

### CROSS-REFERENCE TO RELATED APPLICATIONS

This application claims the benefit of U.S. Provisional Application No. 63/291,390, filed on Dec. 18, 2021, which is hereby incorporated in its entirety.

### FIELD OF THE INVENTION

The present invention is directed to a device that is attached to a wheelchair. More particularly, the invention relates to barrier attachments to wheelchairs that create a barrier between the wheel and the outer rim that is used for propelling the wheelchair.

### BACKGROUND OF THE INVENTION

The following description is not an admission that any of the information provided herein is prior art or relevant to the present invention, or that any publication specifically or implicitly referenced is prior art. Any publications cited in this description are incorporated by reference herein. Where a definition or use of a term in an incorporated reference is inconsistent or contrary to the definition of that term provided herein, the definition of that term provided herein applies and the definition of that term in the reference does not apply.

Currently, wheelchairs have a pair of wheels/tires that are in contact with the ground and a smaller diameter outer metal ring/rim which is attached to the spokes of the wheel, which is used for propelling and operating the wheelchair (see, for example, U.S. patent Publication Ser. No. 13/821,214). These wheelchairs, however, have no barrier attached to wheelchair that is covering the wheel. The current designs do not provide a mechanism to prevent transfer of contaminants to the hands and wrists that come in contact with the wheel as it is being propelled by the user gripping the outer wheel rim.

While wheelchair operators have to be especially careful as to not allow any contact of the hands and wrist with the wheel while propelling the wheel chair, this is almost unavoidable. This problem is prevalent for both children and adults. This is an unrecognized problem that could potentially have serious health hazards for the operator of the wheelchair.

Therefore, there exists a need for a device that prevents contaminants transferring from the ground to the hands of the wheelchair operator.

### SUMMARY OF THE INVENTION

The present invention is directed to a barrier attachment for a wheelchair, specifically attached to the wheelchair that is covering the wheel. In an embodiment of the invention, the attachment is a protective barrier. In another embodiment of the present invention, the barrier is used to protect the user of the wheelchair, wherein the user comprises any individual in need of a wheelchair. In certain embodiments, the invention provides protection for the user from potentially serious health hazards from the contaminants that are picked up from the ground and lodged on to the wheels of the wheelchair that come in contact with the user's hands and wrist while operating the wheelchair.

In an embodiment of the present invention, the barrier attachment device is removably fitted to a wheelchair, wherein the device is a seamless panel comprising a curved, elongated portion comprising a top surface and a bottom surface; a vertical portion comprising a front surface and a rear surface; and a plurality of screws, wherein the plurality of screws are configured to connect the device to an arm of a wheelchair.

In another embodiment of the present invention, the curved, elongated portion is configured to cover the top arch of the wheelchair without touching the wheelchair. In another embodiment of the present invention, wherein the curved, elongated portion is about 24 inches in length. In another embodiment, the present invention, wherein the vertical portion is about 6 to 12 inches in length.

In another embodiment, the present invention is about 2 to 4 inches thick. In another embodiment, the plurality of screws are located on the front surface of the vertical portion and are configured to attach the barrier attachment device to an arm of the wheelchair.

In a further another embodiment, the curved, elongated portion comprises metal, plastic, rubber, Plexiglas, or any combination thereof. In another embodiment, the protective cover wherein the plurality of screws comprises metal or steel material.

In yet another embodiment, the barrier attachment device is removably attached to a wheelchair by hook and loop tape, hooks, or wire tie strip.

Various objects, features, aspects and advantages of the inventive subject matter will become more apparent from the following detailed description of exemplary embodiments, along with the accompanying figures in which numerals represent like components.

### BRIEF DESCRIPTION OF THE DRAWINGS

FIG. 1 is an exemplary configuration of the barrier attachment according to the present invention, which depicts a side view of the barrier with screws used for attachment.

FIG. 2 is an exemplary configuration of the barrier attachment according to the present invention, which depicts the barrier attached to a wheelchair, in its respective configuration.

FIG. 3 is an exemplary configuration of the barrier attachment according to the present invention, which depicts a close-up view of the barrier attached to a wheelchair.

FIG. 4 is an exemplary embodiment of the present invention that depicts a user's hand on the rim of a wheelchair.

FIG. 5 is an exemplary embodiment of the present invention that depicts the rear view of the barrier.

### DETAILED DESCRIPTION

The present invention is directed to a wheelchair barrier attachment device. In an embodiment, the barrier attachment is configured to protect the wheelchair operator from potentially serious health hazards contracting from the contaminants that are located on the wheel of the wheelchair.

As used herein, and unless the context dictates otherwise, the term “barrier” is intended to include the barrier itself along with the place of attachment involving screws. Therefore, the terms “device”, and “barrier” “” may be used interchangeably.

Furthermore, as used herein, and unless the context dictates otherwise, the terms “user” and “operator” are intended to include a child, adult or anyone who uses a wheelchair. In an embodiment of the present invention, the barrier is used in wheelchairs, including but not limited to standard wheelchairs, light-weight wheelchairs, and ultralight weight wheelchairs.

As used in the description herein and throughout the claims that follow, the meaning of “a,” “an,” and “the” includes plural reference unless the context clearly dictates otherwise. Also, as used in the description herein, the meaning of “in” includes “into” and “on” unless the context clearly dictates otherwise.

As used herein, the term “about” in conjunction with a numeral refers to a range of that numeral starting from 10% below the absolute of the numeral to 10% above the absolute of the numeral, inclusive.

Furthermore, in an embodiment, the barrier is made of any natural or synthetic material to prevent any damage to the wheelchair. In other embodiments, examples of material of construction include metal, plastic, rubber, Plexiglas, or any combination of the aforementioned materials, including materials of flexible degree, and combinations of materials that are flexible along with relatively less flexible or inflexible materials. A skilled person in the art will be readily able to select a suitable material of construction for the barrier based on the operating conditions and requirements in the configurations contemplated herein.

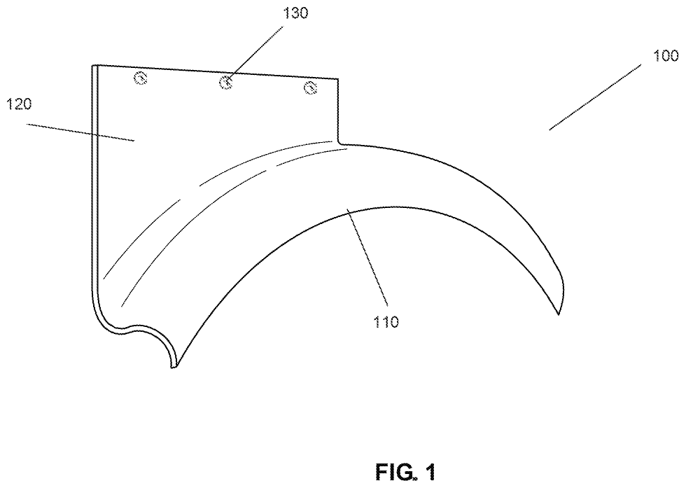

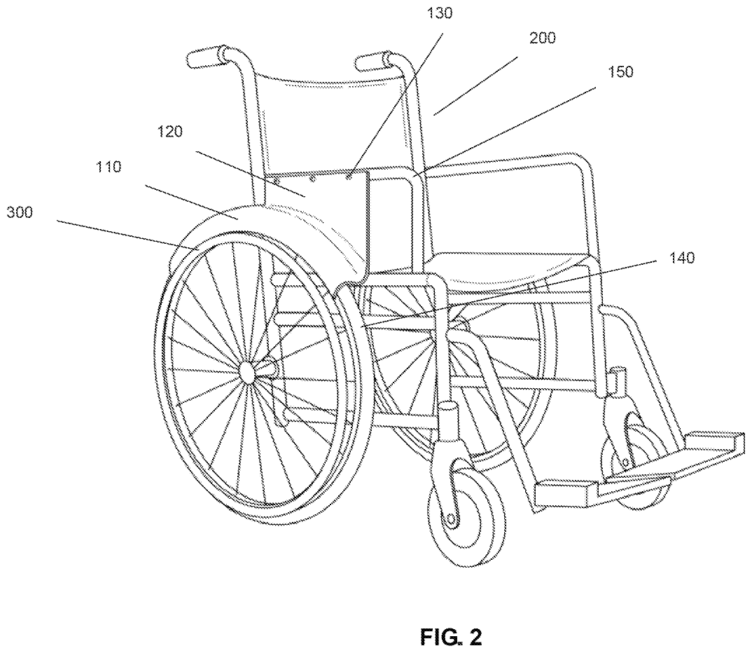

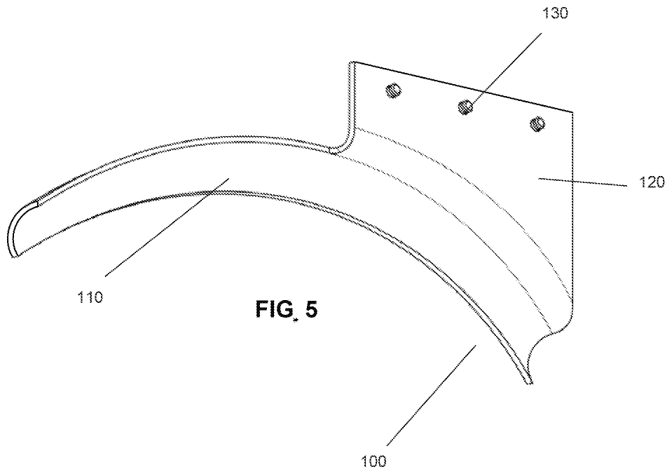

Exemplary embodiments of device 100 are depicted in FIGS. 1-5. In one embodiment, as depicted in FIG. 1, device attachment 100 is designed and adapted for use in connection with wheelchair 200 and the operation of maneuvering wheelchair 200 (not shown). In an embodiment, device 100 is a seamless panel comprising a curved, elongated portion 110 and a vertical portion 120 that face the external environment. In an embodiment, curved, elongated portion 110 comprises a top surface and a bottom surface. In an embodiment, vertical portion 120 comprises a front surface and a rear surface. Device 100 is configured to cover the top arch of wheel 140 without touching wheel 140. In an embodiment, plurality of screws 130 are located on vertical portion 120. In an embodiment, barrier 100 is removably fitted to wheelchair 200 through plurality of screws 130. In one embodiment, device 100 is removably attached to both arms 150 of wheelchair 200 through a plurality of screws 130 (not shown.)

In an embodiment, device 100 is removably attached through other means of attachment, such as hook and loop tape, hooks, wire tie strip for easy removal of device 100 from wheelchair 200.

In an embodiment, device 100 is manufactured from flexible materials such as rubber material allowing curved elongated panel 110 to prevent damage to wheelchair 200 and any injury to wheelchair 200 operator. In another embodiment, plurality of screws 130 are configured to connect barrier 100 to arm 150 of wheelchair 200.

In an exemplary embodiment, barrier 100 is configured to provide a protective screen for the user of wheelchair 200 from contaminants located on the wheel. In another embodiment, vertical portion 120 is manufactured from a combination of natural or synthetic materials including rubber or plastic to allow for easy cleaning. In an embodiment, plurality of screws 130 are manufactured from metal or steel materials or any combination thereof.

In another embodiment, barrier 100 is of a size that is sufficiently long and wide to substantially cover the top of wheel 140 of wheelchair 200. In an embodiment, barrier 100 is about 24 inches long to cover the length of the wheelchair based on its average diameter of the wheel. In another embodiment, vertical portion 120 is about 6 to 12 inches in length. In one embodiment, device 100 is about 2 to 4 inches thick. One of ordinary skill in the art can envision other dimensions which may vary with the type of wheelchair and the size of wheelchair for each individual user without detracting from the spirit of the invention.

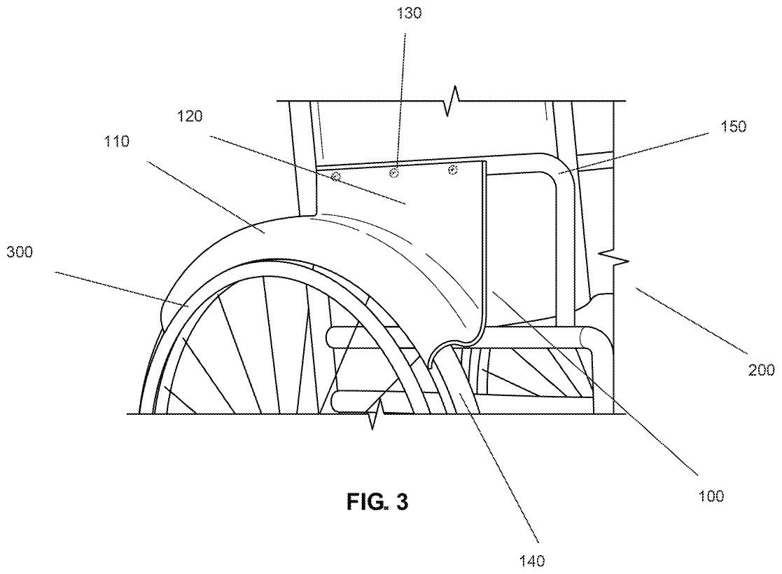

In one example, barrier 100 is attached using a plurality of screws 130 to arm 150 of the chair on wheelchair 200 (see FIG. 3). In this embodiment, a plurality of screws 130 are removably attached from device 100 allowing an easier way to attach or remove the side of wheelchair 200.

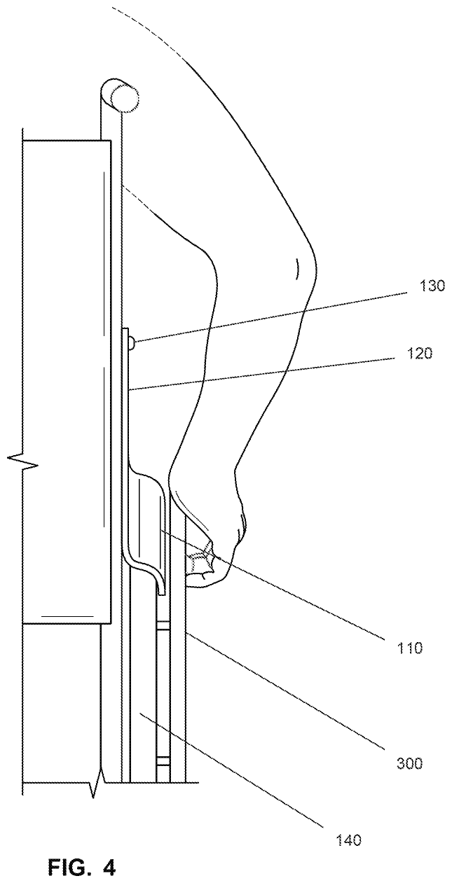

FIG. 4 depicts the user's operation of wheelchair 200 while barrier 100 is integrated with wheelchair 200. In this embodiment, the user operates wheelchair 200 by rotating rim 300 of wheel 140 while the user's arm is extending over the curved elongated portion 110, such that the user's hand can grasp rim 300 of wheel 140.

Thus, exemplary embodiments of a wheelchair barrier attachment device have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A barrier attachment device is removably fitted to a wheelchair, wherein said device is a seamless panel comprising:
a) a curved, elongated portion comprising a top surface and a bottom surface;
b) a vertical portion comprising a front surface and a rear surface; and
c) a plurality of screws, wherein said plurality of screws are configured to connect said device to an arm of said wheelchair.

2. The barrier attachment device according to claim 1, wherein said curved, elongated portion is configured to cover the top arch of said wheelchair without touching said wheelchair.

3. The barrier attachment device according to claim 2, wherein said curved, elongated portion is about 24 inches in length.

4. The barrier attachment device according to claim 1, wherein said vertical portion is about 6 to 12 inches in length.

5. The barrier attachment device according to claim 1, wherein said device is about 2 to 4 inches thick.

6. The barrier attachment device according to claim 1, wherein said plurality of screws are located on said front surface of said vertical portion and are configured to attach said barrier attachment device to an arm of said wheelchair.

7. The barrier attachment device according to claim 1, wherein said curved, elongated portion comprises metal, plastic, rubber, Plexiglas, or any combination thereof.

8. The barrier attachment device according to claim 1, wherein said plurality of screws comprise metal or steel material.

9. The barrier attachment device of claim 1, wherein said device is configured to provide a protective screen for the user of said wheelchair from contaminants located on a wheel of said wheelchair.

10. A barrier attachment device is removably fitted to a wheelchair, wherein said device is a seamless panel comprising:
a) a curved, elongated portion comprising a top surface and a bottom surface;
b) a vertical portion comprising a front surface and a rear surface; and
c) a plurality of screws,
wherein:
i. said plurality of screws are located on said vertical portion; and
ii. said plurality of screws are configured to connect said device to an arm of said wheelchair.

11. The barrier attachment device according to claim 10, wherein said curved, elongated portion is configured to cover the top arch of said wheelchair without touching said wheelchair.

12. The barrier attachment device of claim 10, wherein said device is configured to provide a protective screen for the user of said wheelchair from contaminants located on a wheel of said wheelchair.

13. The barrier attachment device of claim 10, wherein said plurality of screws are located on said front surface of said vertical portion and are configured to attach said barrier attachment device to an arm of said wheelchair.

14. The barrier attachment device according to claim 10, wherein said curved, elongated portion comprises metal, plastic, rubber, Plexiglas, or any combination thereof.

15. The barrier attachment device according to claim 10, wherein said plurality of screws comprise metal or steel material.

16. A barrier attachment device is removably fitted to a wheelchair, wherein said device is a seamless panel comprising:
a) a curved, elongated portion comprising a top surface and a bottom surface, wherein said elongated portion is configured to cover the top arch of said wheelchair without touching said wheelchair;
b) a vertical portion comprising a front surface and a rear surface; and
c) a plurality of screws,
wherein:
i. said plurality of screws are located on said vertical portion; and
ii. said plurality of screws are configured to connect said device to an arm of said wheelchair.

17. The barrier attachment device according to claim 16, wherein said device is configured to provide a protective screen for the user of said wheelchair from contaminants located on a wheel of said wheelchair.

18. The barrier attachment device according to claim 16, wherein said curved, elongated portion comprises metal, plastic, rubber, Plexiglas, or any combination thereof.

19. The barrier attachment device of claim 16, wherein said device is configured to provide a protective screen for the user of said wheelchair from contaminants located on a wheel of said wheelchair.

20. The barrier attachment device of claim 16, wherein said device is removably attached to said wheelchair by hook and loop tape, hooks, or wire tie strip.
